(19) United States
(12) Patent Application Publication
(10) Pub. No.: US 2026/0093820 A1
(43) Pub. Date: Apr. 2, 2026

(54) Centralized Vulnerability Security Scanning And Distributed Detection

(71) Applicant: Oracle International Corporation, Redwood Shores, CA (US)

(72) Inventors: Kanishk Panwar, Sammamish, WA (US); Yatin P. Patil, Bothell, WA (US); Norman Wesley Ackroyd, Kirkland, WA (US); Chinmay Jain, Seattle, WA (US); Micah Will Miller, Seattle, WA (US)

(73) Assignee: Oracle International Corporation, Redwood Shores, CA (US)

(21) Appl. No.: 18/902,621

(22) Filed: Sep. 30, 2024

(51) Int. Cl. G06F 21/57; H04L 9/40

(52) U.S. Cl. CPC G06F 21/577; H04L 63/205; G06F 2221/033

(57) ABSTRACT

Techniques for a centralized vulnerability security scanning and distributed detection system are disclosed. Some techniques set forth a set of operations including receiving, in a first cloud environment of a cloud system, image scan results from a second cloud environment of the cloud system, receiving container identity data from a particular deployed container of a set of deployed containers in the first cloud environment, based on a comparison between the image scan results and the container identity data, determining that the particular deployed container of the set of deployed containers is running a vulnerable software product, and generating, for presentation on a graphic user interface (GUI), information associated with the vulnerable software product. The image scan results correspond to a vulnerability scan of a plurality of software products running in the set of deployed containers.

### TECHNICAL FIELD

The present disclosure relates to cloud computing. In particular, the present disclosure relates to a cloud system having multiple cloud environments.

### BACKGROUND

Cloud computing technologies can be used to provide access to a range of complementary cloud-based components, such as software applications or services, which enable organizational, individual, or enterprise customers to operate their applications and services in a highly available hosted cloud computing environment (or simply “cloud environment”). An entity operating as a cloud service provider (CSP) can use these technologies to manage and control access to their customers'cloud environments. The benefits of moving their application and service needs to a cloud environment include a reduction in the cost and complexity of designing, building, operating, and maintaining their own on-premises data center, software application framework, networking infrastructure, or other information technology.

Deploying resources in cloud environments can be complicated by specific customers'needs, preferences, and expectations. To illustrate by way of example, a deployment schedule that is appropriate for one customer may not be appropriate for another customer. Alternatively or additionally, different customers may have different needs that affect when, how, and/or by whom resources can be deployed. For example, a customer may be a government organization and require strict regulatory compliance and either complete or near-complete isolation of any deployed resources in their cloud environment. In general, in a customer's cloud environment, the CSP has to balance the customer's needs and preferences with that same customer's expected service level from the CSP, particularly, in terms of cloud security, privacy, redundancy, and availability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2A illustrates a first example set of operations and FIG. 2B illustrates a second example set of operations for centralized vulnerability security scanning and distributed detection in accordance with one or more embodiments;

FIG. 3 illustrates an example embodiment of a tenant console in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. General Overview
2. Centralized Vulnerability Security Scanning and Distributed Detection System
3. Centralized Vulnerability Security Scanning and Distributed Detection
4. Example Embodiment
5. Computer Networks and Cloud Networks
6. Microservice Applications
7. Hardware Overview
8. Miscellaneous; Extensions

### 1. General Overview

One or more embodiments include a centralized vulnerability security scanning and distributed detection system. A cloud system operated by a CSP can implement the centralized vulnerability security scanning and distributed detection system for its advantages and benefits. For one, the CSP can run scanning mechanisms that continuously or periodically scan image files, such as container image files, with more efficiency and effectiveness than any of its customers can. To reduce resource consumption within the customer's cloud environment, the CSP runs the above scanning mechanisms in a different cloud environment and provides only the scan results to the customer. The customer benefits from having more of its own cloud resources to focus on detecting and/or remediating vulnerabilities within its own tenancy.

Customers of the CSP typically do not have any control over when resources are deployed to their cloud environments but are expected to handle vulnerability scanning, detection, and overall security. Some customers desire isolation from the cloud system and retention of control over resource deployments; for these customers, the CSP should be restricted in what changes can be made to the customers'cloud environments. While these customers want to determine which software products are deployed, these customers also desire freedom from software products with detrimental vulnerabilities. To provide these customers with their desired level of control and security, one or more embodiments implement a cloud service to detect vulnerable software products in the customer's cloud environment while directing a different cloud environment to perform vulnerability security scans on the customer's image files.

The CSP can provide vulnerability security scan results (hereinafter referred to as “scan results”) to their customers who then can leverage its insights into determining which (if any) of its active applications, services, or devices include a vulnerable software product that is currently active in their respective cloud environments. A vulnerable software product (which alternatively may be referred to as an artifact) generally refers to a software package, a deployable unit in a container image, and a security vulnerability that may run as part of and to the possible detriment of that container image's deployment to the customer's cloud environment. The above cloud service can be configured to analyze the scan results and quickly identify specific data for the container image. By doing so, the cloud service can immediately determine whether the corresponding deployed container is running the vulnerable software product.

Various embodiments implement a cloud service to run in an isolated cloud environment and to validate a schema used in the scan results such that individual schema attributes are identifiable. In one embodiment, by mapping the schema used in the scan results to attributes used for identifying containers that have been deployed, the cloud service enables the detection of any vulnerable software product running in a deployed container. To illustrate by way of examples, because there are attributes used in the scan results that describe the vulnerable software product and the scanned container image, the above cloud service manager can map those attributes to a known schema for internal container attribute information. By doing so, the cloud service can ignore unrelated data and identify the vulnerable software product running in the corresponding deployed container. As another advantage, the cloud service can access container identity data from individual deployed containers. As yet another advantage, even though the CSP does not know which containers are deployed at a given time, the CSP can use the above-mentioned cloud service to keep track of deployed containers running vulnerable software products.

There are a number of additional benefits and advantages from implementing the above cloud service for the customer's cloud environment. For one, instead of having its customers manage the results from the vulnerability security scans searching for vulnerabilities in container images, the CSP can run a push-oriented mechanism to distribute scan results amongst its customers. By having the CSP implement a trusted communication channel to a customer's cloud environment, the CSP can still provide scan results while maintaining some degree of isolation for the customer's cloud environment. Therefore, centralizing security scan operations to a designated cloud environment of the cloud system enhances the operation and security of resources in a separate and/or independent cloud environment such as one under a tenancy of a CSP customer.

One or more embodiments described in this Specification and/or recited in the claims may not be included in this General Overview section.

### 2. Centralized Vulnerability Security Scanning and Distributed Detection System

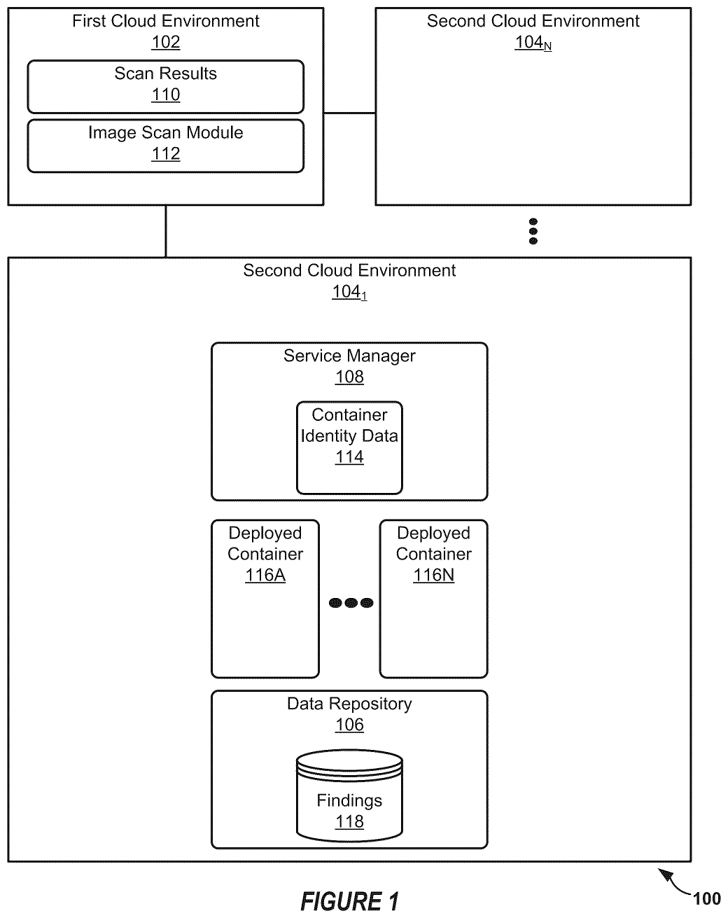

FIG. 1 illustrates a system 100 in accordance with one or more embodiments. As illustrated in FIG. 1, system 100 includes a first cloud environment 102 and a set of second cloud environments 104₁-104_{N}. It should be noted that the first cloud environment 102 and the set of second cloud environments 104₁-104_{N} are examples of cloud networks. It should be further noted that the set of second cloud environments 104₁-104_{N} includes at least one isolated cloud environment and/or at least one connected cloud environment. The system 100, as explained in detail below, can operate a centralized vulnerability security scanning and distributed detection system configured to correlate provider-side image scan results and tenant-side container identity data and determine which software products running in the isolated cloud environment 104 have vulnerabilities.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

In one embodiment, an entity known as a CSP operates the first cloud environment 102 while another entity operates the second cloud environment 104₁. The other entity may be a non-commercial organization and a customer of the CSP. The second cloud environment 104₁ may be an isolated cloud environment and therefore, communications between the first cloud environment 102 and the second cloud environment 104₁ are, for the most part, prohibited. There are example embodiments where some communications are permitted. As an alternative, the CSP's customer can operate a connected cloud environment instead of the second cloud environment 104₁ and avail the benefits of the system 100.

Various embodiments of the system 100 enhances security, for instance, by conferring the benefits of run-time vulnerability security scans while maintaining a separate and independent cloud environment for the customer. By performing scanning operations in the CSP's first cloud environment 102 and detection operations in the customer's second cloud environment 104₁, more of the customer's cloud resources are conserved for other uses. Some embodiments implement a trusted communication channel between the first cloud environment 102 and the second cloud environment 104₁, thereby maintaining isolation and security for the CSP customer. Therefore, even when completely isolated, various embodiments of the system 100 can configure the CSP's cloud environment, the first cloud environment 102, to communicate container image scan results data to the CSP customer's cloud environment second cloud environment 104₁.

In one or more embodiments, a data repository 106 is any type of storage unit and/or device (e.g., a file system, database, collection of tables, or any other storage mechanism) for storing data. Further, a data repository 106 may include multiple different storage units and/or devices. The multiple different storage units and/or devices may or may not be of the same type or located at the same physical site. Further, a data repository 106 may be implemented or executed on the same computing system as the cloud environment 102. Additionally, or alternatively, the data repository 106 may be implemented or executed on a computing system separate from the cloud environment 102. The data repository 106 may be communicatively coupled to the cloud environment 102 via a direct connection or via a network.

Information describing known artifact vulnerabilities and their related findings may be implemented across any of components within the system 100. However, this information is illustrated within the data repository 106 for purposes of clarity and explanation.

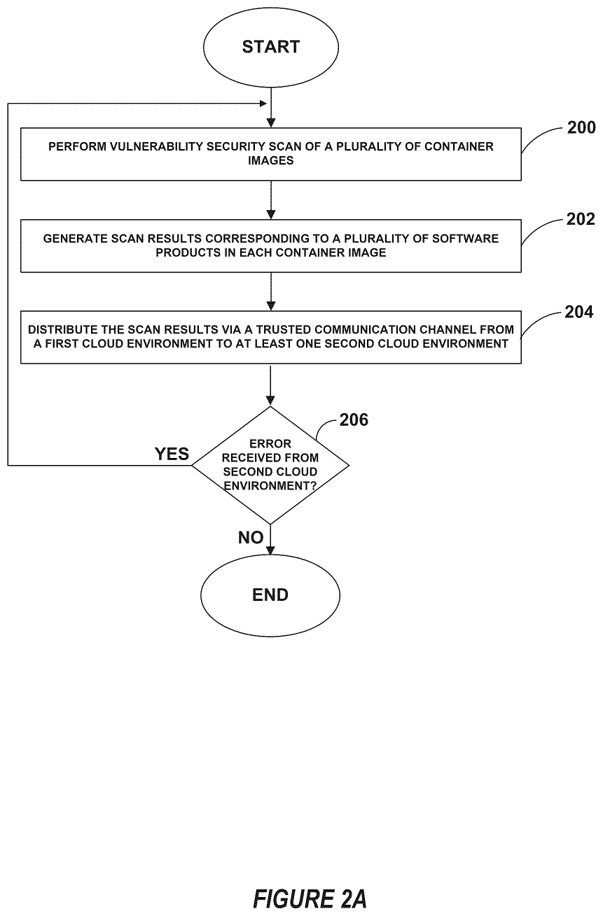

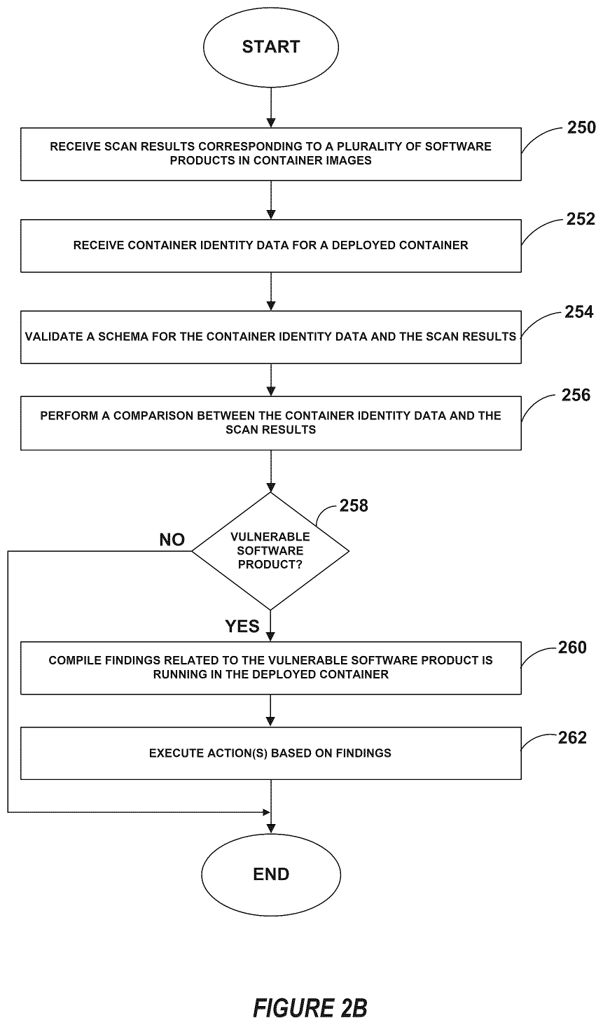

Various embodiments implement service manager 108 for performing a set of operations for the system 100. In one or more embodiments, the service manager 108 refers to hardware and/or software configured to perform operations described herein for centralized vulnerability security scanning and detection by way of correlating provider-side image scan results data with tenant-side deployed container data. Examples of operations for centralized vulnerability security scanning and distributed vulnerability detection by way of correlating provider-side image scan results data with tenant-side deployed container data are described below with reference to FIG. 2.

In an embodiment, the service manager 108 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

The second cloud environment 104₁ receives scan results 110 from the first cloud environment 102 and then stores the scan results 110 in the data repository 106 according to one embodiment. In one embodiment, both the first cloud environment and the second cloud environment 104₁ employ a trusted communication channel to avail its security features when transferring files, including the scan results 110, to each another. To later retrieve the scan results 110 from the data repository 106, the service manager 108 submits an access request to the data repository 106. In response to determining that the access request failed to return the scan results 110, the service manager 108 resubmits the access request to the data repository 106 unless a pre-defined threshold number of resubmissions (i.e., retries) has been reached.

An image scan module 112, running in the cloud environment 102, generates the scan results 110 while/after performing a vulnerability security scan searching for software products considered vulnerable to exploitation and then, distributes the scan results 110 to other cloud environments of the same cloud system. In one embodiment, the image scan module 112 operates an example service in the first cloud environment 102 for performing the vulnerability security scan on any given container image(s), as directed by a corresponding service operated by the service manager 108, on behalf of any service clients in the second cloud environment 104₁. In one embodiment, the image scan module 112 performs the vulnerability security scan on the given container image(s), as directed by a service level agreement between the first cloud environment 102 and the second cloud environment 104₁.

The image scan module 112 generates the scan results 110 by executing code for the vulnerability security scan. In one embodiment, the image scan module 112 performs the vulnerability security scan on image files—including container images composed of software packages for operating systems, applications, devices, and services—and identifies software packages for vulnerable software products. The image scan module 112 determines which software products are to be instantiated when deploying the container and through a number of scanning techniques, whether any of those software products are security concerns (i.e., vulnerable software products). The image scan module 112 can scan one or more container images for vulnerable software products and distribute any findings 118 along with corresponding scan results 110 to the service manager 108. There is no need for the second cloud environment 104₁ to transmit binaries given that the container images can be obtained from a secure registry in the cloud environment 102.

The image scan module 112 may include tools such as static analysis (SAST), dynamic analysis (DAST), and software composition analysis (SCA) to scan software artifacts for known vulnerabilities. In an embodiment, the image scan module 112 determines a vulnerability level for detected vulnerabilities. For example, a common vulnerability scoring system (CVSS) may score vulnerabilities and assign a corresponding severity level (e.g., Low, Medium, High, Critical). The score an severity level may be computed and assigned based on one or more factors, such as how easily the vulnerability can be exploited locally or remotely, what privileges are required to exploit the vulnerability, whether the exploit can leak or modify sensitive data, and whether an exploit of the vulnerability can make the software or system unavailable. The image scan module 112 may include the vulnerability scores and/or assigned labels indicative of the severity level of a detected vulnerability within the scan results.

In general, the findings 118 refer to documents, records, publications, articles, and/or the like generated by security organizations (e.g., government agencies and/or industry partners) regarding publicly disclosed cybersecurity issues including vulnerabilities and other threats. One example of the findings 118 include Common Vulnerabilities and Exposures (CVE) records in which each record uniquely identifies a publicly known software or hardware security vulnerability. CVE is a sponsored program whose mission is to identify, define, and catalog publicly disclosed cybersecurity vulnerabilities. Information technology and cybersecurity professionals use CVE Records to ensure they are discussing the same issue, and to coordinate their efforts to prioritize and address the vulnerabilities. CVE records in the findings 118 typically include information about the vulnerability itself, such as its type, the vendor of the affected product, and the affected code base. The findings 118 may map a particular CVE record to each container image in the scan results 110 in which a corresponding vulnerability has been found.

In one embodiment, the scan results 110 include a plurality of datasets of which each dataset is associated with a specific container image and includes a number of attributes generated from scanning that container image's contents. Some example attributes include a set of tuples comprising version identifiers for a plurality of software products in a specific container image (e.g., a version set) and corresponding vulnerability levels/scores for the version set. The image scan module 112 may configure the scan results 110 into an adaptable implementation for any content type or data type such as in an array. As another example, the scan results 110 may be arranged into a data table where each entry (i.e., row) corresponds to the specific container image and each attribute (i.e., column) corresponds to a specific software product version; therefore, an example column includes a Boolean value indicating whether the specific container image stores a package for the specific software product version and if so, an Integer value indicating whether the specific software product version constitutes a vulnerability for the specific container image. Examples of these software products (which may be referred to as artifacts) include any deployable unit such as a Docker image, rpms, or tar.gz archive.

In one embodiment, after successfully scanning container image file(s) and other computer files for any vulnerable software products (including specific versions), the image scan module 112 generates, for the scan results 110, the set of tuples comprising for each container image, a version set and corresponding vulnerability information for each software product version. In another embodiment, the image scan module 112 also records an identity for the container image being scanned, such as a container identifier, or container_id, or an image name. To enable a comparison with the container identity data 114 and an efficient search of the scan results 110, the service manager 108 validates a schema used in the scan results 110 to ensure that the above recorded image attributes map to a schema used in the container identity data 114. To ensure that the comparison yields a trustworthy detection, the image scan module 112 also records a cryptographic hash value, or simply a hash value, to use as a digital signature for each scanned container image.

Some, but not all, container images that are available for security scanning are actually deployed and running in the second cloud environments 104, let alone the second cloud environment 104₁ specifically. For the image scan module 112 to accurately track which vulnerable software products are running in the second cloud environment 104₁, the image scan module 112 communicates the scan results 110 from the above vulnerability security scan. In turn, the service manager 108 executes a workflow that compares the scan results 110 to the container identity data 114.

As explained further below, the service manager 108 in the second cloud environment 104₁ can use container identity data 114 to intelligently process the scan results 110 for information corresponding to any vulnerable software products currently running in one or more deployed containers 116A-116N. The service manager 108 can have detection results returned to the image scan module 112 by a third-party and/or publish detection results into an event feed for the second cloud environment 104₁. The image scan module 112 also may receive detection results from a different service and/or application. Therefore, by transmitting the scan results 110 to the second cloud environment 104₁ from the first cloud environment 102, the image scan module 110 can track vulnerabilities in the deployed containers 116A-116N of a different cloud environment. The ability to track vulnerabilities from the first cloud environment 102 is maintained even though the first cloud environment 102 is not connected to the second cloud environment 104₁ according to one embodiment. In one embodiment, the image scan module 110 retains the ability to track from the first cloud environment 102 vulnerabilities in the deployed containers 116A-116N even when the second cloud environment 104₁ cannot receive any data from the first cloud environment 102, for instance, due to being isolated from the first cloud environment 102. The first cloud environment 102 may also provide scan results for software artifacts that have been pushed although the first cloud environment 102 is not able to determine whether the software artifacts were ever deployed and running within the second cloud environment 104. While conventional communications are infeasible due to being isolated from each other, the first cloud environment 102 and the second cloud environment 104₁ can still avail the trusted communication channel for distributing the scan results 110.

In one embodiment, the service manager 108 receives the container identity data 114 from the set of deployed containers 116A-116N (hereinafter simply “the deployed containers 116”) by having a service agent, running in each deployed container 116, push information configured to identify the container image and, possibly, any software product running in that deployed container 116. In one embodiment, the service manager 108 can configure an example agent to periodically submit a query for the above-mentioned information to an application running in a corresponding deployed container 116.

In one embodiment, the service manager 108 can use the container identity data 114 to quickly identify datasets in the scan results 110 for the particular deployed container 116 and ignore any other dataset in the scan results 110. Having information associated with the vulnerable software products running in the specific deployed container 116, the service manager 108 can extract specific findings data 118 corresponding only to those vulnerable software products and omit other findings data 118 from content presented to the user via the GUI.

In one embodiment, the service manager 108 generates information regarding the security of the CSP customer's second cloud environment 104₁ and then, presents that information on a tenant console for the system 100. The service manager 108 may present artifact-level finding data 118 for each software product (regardless of vulnerability) in the particular deployed container 116 of the second cloud environment 104₁, for instance, when no scan results 110 are available for the particular deployed container 116. In one embodiment, the service manager 108 presents artifact-specific finding data 118 for the specific vulnerable software product running in the particular deployed container 116.

In one or more embodiments, an interface such as the GUI mentioned above refers to hardware and/or software configured to facilitate communications between a user and the second cloud environment 104₁. The GUI renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of the GUI are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the GUI is specified in one or more other languages, such as Java, C, or C++.

### 3. Centralized Vulnerability Security Scanning and Distributed Detection

FIGS. 2A and 2B illustrate example sets of operations for centralized vulnerability security scanning and distributed detection in accordance with one or more embodiments. One or more operations illustrated in FIG. 2A or 2B may be modified, rearranged, or omitted all together. Accordingly, the particular sequence of operations illustrated in FIG. 2A or 2B should not be construed as limiting the scope of one or more embodiments.

In one embodiment, a system for centralized vulnerability security scanning and distributed detection is a computing system for a cloud computing network that configures at least a first cloud environment and at least a second cloud environment to operate one or more services and/or applications for a first entity and a second entity, respectively. It should be noted that the following describes the second cloud environment as an isolated cloud environment and/or a tenancy of the first cloud environment, the second cloud environment 104₁ may, as an alternative, be a connected to the first cloud environment 102 and other computing systems via conventional communication channels.

One example service executed in the first cloud environment enables scanning and detection of vulnerable software products that are currently running in deployed container(s) within the at least one second cloud environment (i.e., at run-time). The example service may operate with a corresponding service in the second cloud environment and as described herein in detail, enables the centralized vulnerability security scanning while also enabling the corresponding service to effectuate the distributed detection of any vulnerable software products. In one embodiment, the example service performs the vulnerability security scan on a given container image as directed by the corresponding service and any service clients in the second cloud environment.

In one embodiment, the system includes a number of software/hardware components configured to perform the example set of operations illustrated in FIG. 2A and/or the example set of operations illustrated in FIG. 2B. The system includes, as one example system component, an image scan module for operating the above-mentioned example service and communicating with the corresponding service in the second cloud environment. As explained herein in detail, the system can configure the image scan module to operate at least an instance of the above example service in the first cloud environment and perform the example set of operations illustrated in FIG. 2A for the benefit of the first entity and/or the second entity. In a similar manner, the system can configure another system component, a service manager, to operate at least an instance of the above corresponding service in the second cloud environment and perform the example set of operations illustrated in FIG. 2B for the benefit of the first entity and/or the second entity. In one embodiment, the example service of the first cloud environment can direct the above corresponding service operated by the service manager to leverage the vulnerability scan results for detecting any vulnerable software products running in the deployed container(s) of the second cloud environment. In a conventional cloud network, instead of scanning container image(s) in the first cloud environment and leveraging scan results in the second cloud environment, the container image(s) would be scanned in the second cloud environment (where some are to be or already deployed), thereby burdening the second cloud environment with substantially more security tasks to complete.

In one embodiment, the image scan module performs a vulnerability security scan of a plurality of container images (Operation 200). The image scan module invokes various functionality for performing the vulnerability security scan, for instance, by invoking native security scan software executables and/or third-party security software products for scanning a container image's contents (e.g., file data) for any indicia of a software vulnerability. In one embodiment, analyzing the container image's contents allows the image scan module to enumerate the container image's software packages and then determine whether that any software package(s) could later be used (e.g., by a fraudster) to surreptitiously gain access to a computing device running in the first cloud environment or the second cloud environment.

In one embodiment, the image scan module performs the vulnerability security scan on the plurality of container images on behalf of the second entity operating the second cloud environment. It should be noted that such an entity could be the same entity in control of the first cloud environment or a completely different entity. In one embodiment, the image scan module initiates the vulnerability security scan by executing vulnerability security scan functionality. The image scan module may initiate the vulnerability security scan according to a pre-defined schedule and as part of a service level agreement with the second entity and/or the second entity's customers. The image scan module may initiate the vulnerability security scan upon receiving a directive on behalf of its service client(s) and the corresponding service of the second cloud environment.

In one embodiment, the image scan module couples the vulnerability security scan functionality to a service stack for the example service such that service clients, from the second cloud environment, can avail various security benefits. For instance, a service client can submit a function call from the second cloud environment to the example service and initiate the vulnerability security scan of a specific container image file while having a deployed container based on the same specific container image file already running in the second cloud environment. The service client may also be a customer of an entity operating the first cloud environment such as a tenant of a CSP. As such, the service client also may be an operator of the second cloud environment. Alternatively, the service client is not the tenant-operator but a completely different entity.

The vulnerability security scan entails the image scan module invoking the above-mentioned vulnerability security scan functionality such as by applying a number of file scanning techniques to the plurality of container images according to an embodiment. These techniques are configured to analyze software product packages stored within container image files for having any known vulnerabilities. Contemporaneous to the image scan module performing the vulnerability security scan of a particular container image, the second cloud environment may deploy a container based on the same particular container image and/or a deployed container based on the same particular container image may already be running in the second cloud environment.

In general, scanning any given container image produces information associated with each component software package as well as with the container image itself. During the vulnerability security scan, the example service can record various image attributes including a name and a version for each software product. In one embodiment, the example service also records a hash value for each software product including any vulnerable software products. The hash values can be used to map specific scan results to their corresponding containers on a list of deployed container identities.

In one embodiment, the image scan module of the system generates scan results corresponding to a plurality of software products in each container image (Operation 202). Generating the scan results typically follows successfully completing the vulnerability security scan. Alternatively, the scan results may be generated contemporaneously with the vulnerability security scan. An example of the generated scan results described herein sets forth a dataset of various attributes for each of the plurality of software products. An example dataset may include vulnerability information for a corresponding software product (e.g., a Boolean value for either vulnerable or not vulnerable or a rating/score between 0 and 100) in addition to static and more descriptive attributes such as an image name, a product name, a file name, a product category, a product version, product components and sub-components as well as their versions, and/or the like. The image scan module compiles the datasets into a list or a table data structure and then memorizes the list or table as a scan results file.

In one embodiment, the image scan module of the system distributes the scan results via a trusted communication channel from a first cloud environment to at least one second cloud environment (Operation 204). Given the number of ways the scan results could be altered by a fraudster, specifically, during transmission to other cloud environments and other security concerns of centralized vulnerability secure scanning, the image scan module leverages the trusted communication channel to ensure that the most recent scan results are protected and available in the second cloud environment.

In one embodiment, the image scan module of the system determines whether an error has been received from the second cloud environment (Operation 206). If the image scan module determines that an error has not been received from the second cloud environment (Path NO), the image scan module terminates the example set of operations. At some point, the image scan module proceeds with performing another vulnerability security scan on the plurality of container images. Alternatively, the image scan module performs a vulnerability security scan on a different plurality of container images. After all container scans are processed and there were no errors, the image scan module receives a success message such as an updated watermark file indicating the workflow terminated in success.

If, on the other hand, the image scan module determines that an error has been received (Path YES), the image scan module returns to Operation 200 of the example set of operations and retries the vulnerability security scan. In one embodiment, the image scan module receives one or more example error messages from the service manager in the second cloud environment and in turn, retries the vulnerability security scan on the plurality of container images. Alternatively or additionally, the image scan module evaluates the one or more example error messages and corrects the scan results. One example error message may indicate that the most recent scan results arrived incomplete and/or corrupted. Another example error message may indicate that the most recent scan results arrived before previous scan results were completely processed. Yet another example error message may indicate that a pre-determined expiration time elapsed before the scan results could be completely processed. There may be other errors that occurred but did not interfere with the processing of the scan results, such as a missing watermark file.

In one embodiment, the image scan module retries the vulnerability security scan on the plurality of container images in accordance with a policy. The system may set a default retry policy to enforce on the image scan module for a number of reasons such as to control resource consumption, maintain a service level, among other reasons. In one embodiment, the system may define a retry limit for the image scan module to follow in order to restrict substantial quantities of resources from being used, avoid a bottleneck of security scans, limit any interference with future security scans, and prevent the corresponding service in the second cloud environment from disrupting the operations of the image scan module. As an example, the system may limit the number of possible retries by the image scan module to 3 retries before trying to remediate any of the errors or raising an error to an administrator.

The system may set a default retry policy to only retry the vulnerability security scan for specific errors. Similar to the retry limit, the image scan module follows such a policy to avoid building a backlog of security scan retries and for other reasons. If a corresponding service in the second cloud environment fails to retrieve the scan results and start processing, the image scan module retries the vulnerability security scan. If a corresponding service in the second cloud environment fails to process any portion (e.g., one or more chunks) of the scan results, the image scan module omits retrying the vulnerability security scan. In one embodiment, the image scan module records one or both of the above failures in a local log file. In one embodiment, the image scan module receives from the second cloud environment an error log indicating one or both of the above failures and then records the error log in the local log file.

In one embodiment, the image scan module receives an alarm, for instance, when an error count goes beyond a particular threshold, when a specific error type is raised, and/or when a current service level falls below an expected service level. It should be noted that the alarm may be a message marked as urgent or may refer to a specific message type such as a broadcast message. As an example, the image scan module receives an alarm communicated by a corresponding service in the second cloud environment if there are any delays in scan result processing and/or no new manifest file is available beyond 24 hours. As another example, the image scan module receives an alarm communicated by a corresponding second example service in the second cloud environment if, after 12 hours, the entire scan results are not available or the available scan results are missing container scan data for one or more specific container images. The second example service in the second cloud environment also may publish a staleness metric regarding a quality of the scan results. The staleness metric may be based on the recency of the scan results.

In view of the above, the image scan module may receive additional data from the second cloud environment regardless of whether any errors were reported. The image scan module may receive information identifying deployed container(s) that were detected for running vulnerable software products. The image scan module may proceed to update the findings data for a specific vulnerability and record a container identifier for any deployed container having that specific vulnerability.

FIG. 2B illustrates another example set of operations for centralized vulnerability security scanning and distributed detection in accordance with one or more embodiments. One or more operations illustrated in FIG. 2B may be modified, rearranged, or omitted all together. Accordingly, the particular sequence of operations illustrated in FIG. 2B should not be construed as limiting the scope of one or more embodiments.

As described herein, the system for centralized vulnerability security scanning and distributed detection is capable of detecting vulnerable software products that are currently running in deployed container(s) within the second cloud environment (i.e., at run-time). In one embodiment, the service manager operates a service for detecting the vulnerable software products by leveraging scan results generated in the first cloud environment instead of performing the vulnerability security scans in the second cloud environment. In a conventional cloud network, a tenant-operator would have a same cloud environment perform the operations for scanning container image(s) and detecting any vulnerable software products, thereby burdening the tenant's cloud resources with substantially more security tasks to complete. The tenant may not request scan results from a different cloud environment in order to maintain isolation (if desired) or other security reasons. In the conventional cloud network, the tenant could have the same container image being scanned simultaneously running as deployed container, possibly risking stability of the tenancy.

In one embodiment, the service manager receives scan results corresponding to a plurality of software products in container images (Operation 250). As described herein, the vulnerability scan results are produced by performing vulnerability security scans of the plurality of software products in container image files and other computer files. In one embodiment, instead of scanning the corresponding container image(s) in the second cloud environment, the first cloud environment can prompt the service manager or another software component to leverage the scan results generated by a different cloud environment for detecting vulnerable software products in deployed containers in the second cloud environment.

As described herein, the first cloud environment and the second cloud environment are part of a same cloud network operated by the CSP and one CSP customer is a tenant of the second cloud environment. If connected to each other as well, the scan results can be transmitted from the first cloud environment and the second cloud environment over a connection. Although not required, the CSP customer can request to have the second cloud environment isolated such that its components are not connected from other components of the same cloud network. Even when isolated, the service manager can configure a trusted communication channel to enable communications between the CSP customer's cloud environment and another cloud environment such as the CSP's cloud environment. Each cloud environment maintains a secure data repository for safely storing and securing the scan results from misappropriation. Various embodiments of the system can avail the trusted communication channel to relieve the CSP customer from having to perform vulnerability security scans of the deployed containers in their (isolated) cloud environment, thereby conserving the CSP customer's cloud resources while enhancing security and maintaining isolation for the CSP customer's cloud environment.

In one embodiment, the service manager receives container identity data for a deployed container (Operation 252). In one embodiment, the service manager leverages a software agent running in the deployed container and a specific query construct to obtain a list of containers running on the same host. In one embodiment, the service manager may retrieve a container image identifier from tenant-side container identity data by submitting a query in accordance with OSQuery, which is a construct based on an SQLite query language, to a daemon running inside a given host instance. The daemon runs on the given host instance and collects system information exposed through a read-only virtual SQL database based on SQLite query language.

In one embodiment, the service manager validates a schema for the container identity data and the scan results (Operation 254). In one embodiment, the service manager validates a schema used in the (provider-side) scan results and/or the (tenant-side) container identity data and then determines appropriate attribute data for correlating both datasets. In one embodiment, the validation sets forth a mapping between (tenant-side) attributes for its deployed containers and (provider-side) information regarding known software vulnerabilities in container images, thereby enabling a comparison between the scan results and the container identity data. One example of the appropriate attribute data may be a hash value as described below.

In one embodiment, the scan results include a set of tuples comprising for each container image, a version set and corresponding vulnerability information for each software product version. In another embodiment, the scan results also record an identity for the container image being scanned, such as a container image identifier, or container_id, or an image name. To enable a comparison with the container identity data, the service manager validates the schema of the scan results to ensure that the above recorded image attributes properly map to a schema used in the container identity data. To ensure that the comparison yields a trustworthy detection, the image scan module also records a cryptographic hash value, or simply a hash value, to use as a digital signature for each scanned container image.

Validating the schema enables the service manager to perform a comparison between the container identity data and the scan results (Operation 256). To efficiently filter and search the scan results for a vulnerable software product, the service manager performs a comparison between the provider-side scan results and the tenant-side container identity data for a matching entry for a particular deployed container and then, focuses the search on examining the matching entries amongst the remaining deployed containers. Based on the comparison, the service manager can determine whether the particular deployed container is running a vulnerable software product as explained further below.

In one embodiment, the tenant-side container identity data includes, as an example attribute, a container image identifier for the particular deployed container running on a given host instance. In one embodiment, the provider-side scan results include example attribute information indicating that a container image identifier includes a software package having a name and a version of a vulnerable software product. By correlating these datasets, the service manager can determine whether a deployed container running in the CSP customer's cloud environment includes a vulnerable software product.

In addition to a software product name and a version, the provider-side scan results can store a variety of other data including hash values that are generated from and also uniquely identify container images or specific software packages. In one embodiment, the service manager extracts a hash value to use for correlating the provider-side scan results and the tenant-side container identity data.

In one embodiment, the service manager uses the container image identifier to segregate the scan results for only the container images actually deployed as containers in the second cloud environment. The service manager also can use the container image identifier to enable specific warnings for (only) the deployed container in the second cloud environment.

As described herein, while some of the container images being scanned in the first cloud environment are actually deployed as containers in the second cloud environment, a substantially number of container images are not deployed as containers in the second cloud environment. While some of these container images may be deployed in the second cloud environment at some point in the future, many container images will remain undeployed; more importantly, their scan results are unusable for securing the second cloud environment. For at least this reason, the above-mentioned comparison and subsequent segregation can benefit the CSP customer and their tenancy by filtering out any unusable scan results and retaining mostly useful scan results, thereby reducing cloud resource consumption.

In one embodiment, the service manager determines whether a vulnerable software product, as indicated in the provider-side scan results, is running in a particular deployed container as indicated in the tenant-side container identity data (Operation 258). In one embodiment, the system correlates the provider-side scan results with the tenant-side container identity data to determine a matching container image scan in the scan results for the particular deployed container in the container identity data.

In one embodiment, the service manager may generate a container image hash value associated with the container image identifier found in the collected system information provided by the agent running in the particular deployed container and then, lookup the hash value in the provider-side scan results. Using hash values for the correlation ensures data integrity of the provider-side scan results and in the detection of the vulnerable software product.

In one embodiment, the service manager extracts a hash value from the scan results for a scanned container image having a vulnerable software product, compares the extracted hash value with a hash value in the container identity data for the particular deployed container, and based on the comparison, determine whether the particular deployed container shares the same scanned container image and therefore, the same vulnerable software product. If so, the service manager records the detection of the vulnerable software product running in the second cloud environment.

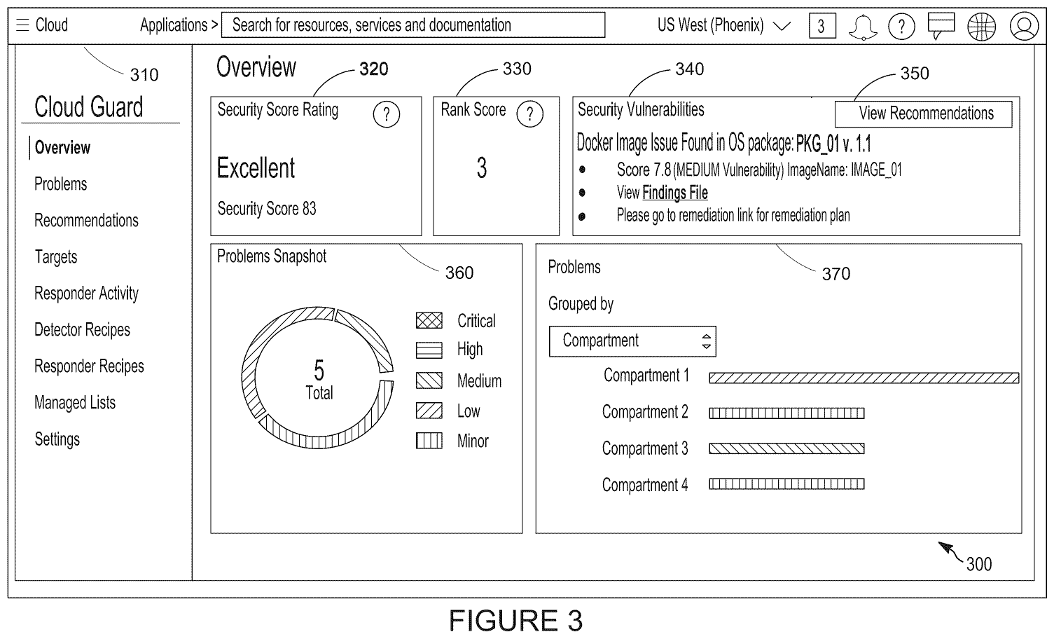

By way of the validation and comparison, the service manager can extract the specific scan results that match the appropriate attribute data for the particular deployed container while disregarding unrelated scan results. Once extracted, the service manager can compile findings data for any vulnerabilities associated with the vulnerable software product running in the particular deployed container. Using the complied findings data and other data, the service manager generates content for presentation on a GUI of which an example embodiment is illustrated in FIG. 3.

If the system identifies the vulnerable software product based on the comparison between the container identity data and the scan results (Path labelled “YES”), the system proceeds to Operation 260. If, on the other hand, the system fails to identify a vulnerable software product (Path labelled “NO”), the system proceeds to terminate the set of the operations.

In one embodiment, the system compiles findings related to the vulnerable software product running in the particular deployed container (Operation 260) and executes one or more actions based on the compiled findings (Operation 262). In one embodiment, the one or more actions include generating content to present on a GUI. The generated content, in general, conveys various information regarding the vulnerable software product to a user of the GUI. It should be noted that the content generated by the system is not limited to the compiled findings, and that the GUI can present content other than the generated content related to the vulnerable software product. The system can generate interactive content in the form of a GUI element that when activated by user input, prompts a cloud service to execute a remediation action for the particular deployed container. The system can compile the findings from different data sources and generally refer to information collected about a specific vulnerability. The system also can communicate the various information to a cloud partition within the same cloud environment for storage. The cloud partition may be separate from a cloud partition in which the particular deployed container is running the vulnerable software product.

Additionally or alternatively, the system may execute one or more other actions based on the scan results and compiled findings. In one embodiment, the system determines what action to execute, if any, based on a vulnerability level associated with a software artifact. For example, the system may determine, based on the information included in the scan results, whether the vulnerability level is above a threshold. If the vulnerability level is above a threshold level of severity (e.g., the score is above a threshold or the label is Critical or High), then the system may implement one or more actions to address the threat. For example, the system may execute one or more automated actions to fix the vulnerability, such as installing a patch. However, isolated environments may be configured to prevent automatic updates and code modifications to enforce tight security constraints. In such cases, other actions may be implemented, such as enforcing a requirement to fix the vulnerability within a predetermined number of days after which the software is disabled within the system and/or sending an urgent notification to a system administrator to update the software artifact. If the artifact has not yet been installed within the target cloud environment and the vulnerability level is above a threshold, then the system may enforce constraints that prevent the software artifact from being installed within the target environment (if already uploaded) or pushed to the target cloud environment. The logic for executing the one or more actions may be contained within the target cloud environment which, as previously noted, may be isolated from the cloud environment deploying the scan results.

An example embodiment of the GUI is illustrated in FIG. 3 as a tenant console for cloud services running in the CSP customer's cloud environment. In one embodiment, the system generates content for presenting an alert warning a user of the tenant console of the vulnerable software product. The alert may be intended for a security team of the CSP customer. The system can generate such an alert under certain conditions such as when the scan results fail an elapsed time requirement, for instance, by exceeding a pre-defined threshold number of days. If the scan results is determined to be devoid of current scan results within the pre-defined threshold number of days, the alert can notify the CSP customer of missing scan data.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

FIG. 3 illustrates an example embodiment of a tenant console 300 in accordance with one or more embodiments. The tenant console 300 generally refers to an interface to services, applications, and devices running in a CSP customer's cloud environment. The tenant console 300 can take the form of a GUI in which interface elements present various content to a user. Specifically, the tenant console 300 enables the presentation of content generated by a system for centralized vulnerability security scanning and distributed detection such as the system 100 described for FIG. 1.

As illustrated, the tenant console 300 presents the generated content to convey information regarding the security of the CSP customer's cloud environment. In one embodiment, the tenant console 300 presents artifact-level finding data for each software product (regardless of vulnerability) in a particular deployed container of the CSP customer's cloud environment. The artifact-level finding data may be used when no vulnerability security scan results are available for the particular deployed container. In one embodiment, the tenant console 300 presents artifact-level finding data for a specific vulnerable software product running in the particular deployed container. The artifact-level finding data is more relevant and useful to the tenant-operator, particularly when compared to unfiltered scan results of substantially more container image files are scanned; most of the scan results are either not current deployed or not even available for deployment in the CSP customer's cloud environment. Furthermore, the CSP customer cannot specifically request the artifact-level finding data from the CSP instead of the unfiltered scan results due, in part, to the isolation between their respective cloud environments preventing the CSP's customer from sending a request. The isolation also prevents the CSP customer from sending a container image file or a software package binary to the CSP's cloud environment for scanning, remediation, and/or the like.

It should be noted that the artifact-level findings data can be a result of centralized vulnerability security scanning and distributed detection as described herein. A service manager running in the CSP customer's cloud environment can filter scan results for any artifacts that are deployed in containers at a same time, which most likely poses a higher risk to the tenant-operator. Each of the filtered artifacts can be mapped to findings data for known vulnerabilities and then, the matching findings data can be partitioned into the artifact-level findings data.

In one embodiment, a security application employed by the CSP customer generates at least some of the content presented on the tenant console 300. The CSP customer's cloud environment may generate the presented content using the artifact-level findings data. One example use case for the artifact-level findings data is described below and also illustrated in FIG. 3 as the security vulnerabilities 340. In one embodiment, the security application publishes the artifact-level findings data for the CSP to access and use for tracking deployed containers, including those with vulnerabilities, in the CSP customer's cloud environment.

As illustrated in FIG. 3, a menu 310 lists a number of candidate target pages for presenting content generated by the security application of which one candidate target page (labelled “Overview”) is selected for display on the tenant console 300 to provide content summarizing the content found on the other candidate target pages. FIG. 3 further illustrates that tenant console 300 includes a number of interface elements (e.g., windows) for providing a security score rating 320, a rank score 330, security vulnerabilities 340, recommendations 350, a problems snapshot 360, and a problems list 370.

In one embodiment, the security score rating 320 is depicted in FIG. 3 by way of a GUI window that includes content items for a security rating and a security score. The security score may be computed using finding data (e.g., CVE records for each vulnerability) for each specific vulnerable software product in the deployed containers running in the CSP customer's cloud environment. One example technique for computing the security score is the Common Vulnerability Scoring System (CVSS) method typically used to supply a qualitative measure of severity of vulnerabilities detected in the deployed containers. CVSS consists of at least three metric groups: Base, Temporal, and Environmental. One or more supplemental metric groups may be defined for computing the security score. There are a number of suitable equations for computing accurate and consistent security scores; one example equation may be a summation of the above three metric groups, base, temporal, and environmental levels. The base calculation measures the intrinsic qualities of a vulnerability that are constant over time and across different user environments. The temporal calculation reflects the characteristics of a vulnerability that change over time. Temporal characteristics include aspects like the remediation level, the exploit code maturity, and the report confidence. The environmental calculation represents the aspects of the vulnerability that are unique to a user's environment. Vulnerabilities with higher security scores make their containers more susceptible to attack and compromise and are areas of higher weakness for the cloud environment.

The security rating measures severity by defining multiple tiers for the security score. The security rating helps indicate the severity with greater accuracy and representation of actual vulnerability severity. As illustrated in FIG. 3 for the security score rating 320, a security score for the customer's cloud environment is computed to be 83, which falls into an excellent tier level as a security rating.

In one embodiment, the rank score 330 is depicted in FIG. 3 by way of a GUI window that includes a content item for a rank score associated with a priority of the CSP customer's cloud environment.

In one embodiment, the security vulnerabilities 340 is depicted in FIG. 3 by way of a GUI window that includes content items for an artifact-level finding. As illustrated in FIG. 3, an operating system package “PKG_01 v. 1.1” is an example artifact and a vulnerability has been found in an associated image. The above example artifact has a specific security score computed using the CVSS method. The security vulnerabilities 340 depicted in FIG. 3 includes a link directing the viewer to a more detailed findings file for the above artifact. The security vulnerabilities 340 depicted in FIG. 3 includes a remediation link directing a viewer to a remediation plan for resolving the vulnerability. The security vulnerabilities 340 depicted in FIG. 3 further includes a GUI button to view the recommendations 350 for resolving the security vulnerabilities 340. One example recommendation 350 may be to execute the remediation plan.

In one embodiment, the problems snapshot 360 is depicted in FIG. 3 by way of a GUI window that provides a visual graph for summarizing a breakdown of the known vulnerabilities detected in the CSP customer's cloud environment. As illustrated in FIG. 3 for the problems snapshot 360, the breakdown of the known vulnerabilities according to severity is as follows: critical, high, medium, low, and minor.

In one embodiment, the problems list 370 is depicted in FIG. 3 by way of a GUI window that provides functionality for sorting the known vulnerabilities detected in the CSP customer's cloud environment according to some criteria. As illustrated in FIG. 3 for the problems 370, the known vulnerabilities detected in the CSP customer's cloud environment are grouped according to the particular compartment in which the vulnerabilities were found.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

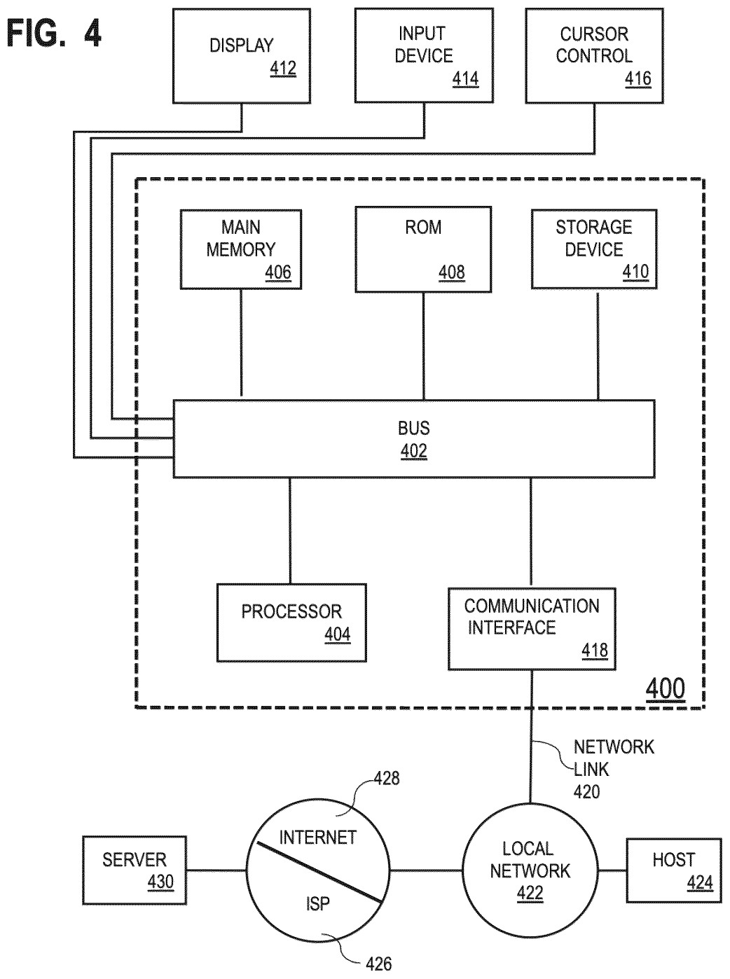

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving, by a service manager in a first cloud environment of a cloud system, image scan results from a second cloud environment of the cloud system, the image scan results corresponding to a vulnerability scan of a plurality of software products running in a set of deployed containers in the first cloud environment, wherein the first cloud environment operates separately from the second cloud environment;
receiving, by the service manager, container identity data from a particular deployed container of the set of deployed containers in the first cloud environment;
based on a comparison between the image scan results and the container identity data, determining, by the service manager, that the particular deployed container of the set of deployed containers is running a vulnerable software product;
generating, for presentation on a graphic user interface (GUI), information associated with the vulnerable software product; and
wherein the method is performed by at least one device including a hardware processor.

2. The method of claim 1, wherein the first cloud environment is an isolated cloud environment in the cloud system.

3. The method of claim 1, wherein the information further comprises artifact-level finding data for the particular deployed container or artifact-specific finding data for the vulnerable software product running in the particular deployed container.

4. The method of claim 1, wherein the information further comprises a GUI element that when activated by user input, prompts the service manager to execute a remediation action for the particular deployed container.

5. The method of claim 1, wherein generating the information further comprises responsive to determining that the image scan results fail an elapsed time requirement:
generating, for presentation on the GUI, content comprising an alert notifying an entity of missing image scan data.

6. The method of claim 1, wherein generating the information further comprises communicating the information associated with the vulnerable software product from a first cloud partition of the first cloud environment to a second cloud partition of the first cloud environment.

7. The method of claim 1, wherein the second cloud environment transmits the image scan results via a trusted communication channel between the second cloud environment and the first cloud environment, wherein the image scan results are stored in a secure data repository.

8. The method of claim 1, wherein receiving the image scan results further comprises submitting, by the cloud service manager, an access request to retrieve the image scan results from a data repository in the first cloud environment.

9. The method of claim 8 further comprising responsive to determining that an access request, submitted to a data repository in the first cloud environment, failed to return the image scan results: resubmitting the access request to the data repository unless a pre-defined threshold has been reached.

10. The method of claim 1, wherein receiving the container identity data further comprises validating a schema used in the image scan results for identifying the particular deployed container amongst the set of deployed containers, wherein the schema used in the image scan results maps to a schema used in the container identity data.

11. The method of claim 10, wherein the comparison between the image scan results and the container identity data determines a matching container image scan in the image scan results for the particular deployed container.

12. The method of claim 11, wherein the container identity data comprises a container image identifier for the particular deployed container running on a given host instance.

13. The method of claim 12, wherein the image scan results further comprise a name and a version of the vulnerable software product running in the particular deployed container.

14. The method of claim 10, wherein the comparison between the image scan results and the container identity data determines a matching software product running in the particular deployed container for the vulnerable software product in the image scan results.

15. The method of claim 14, wherein the container identity data comprises a hash value for a specific software product running in the particular deployed container, wherein when compared to a hash value included in the image scan results, the specific software product is determined to match the vulnerable software product.

16. A system comprising:
one or more hardware processors;
one or more non-transitory computer-readable media; and
program instructions stored on the one or more non-transitory computer readable media which, when executed by the one or more hardware processors, cause the system to perform operations comprising:
receiving, by a service manager in a first cloud environment of a cloud system, image scan results from a second cloud environment of the cloud system, the image scan results corresponding to a vulnerability scan of a plurality of software products running in a set of deployed containers in the first cloud environment, wherein the first cloud environment operates separately from the second cloud environment;
receiving, by the service manager, container identity data from a particular deployed container of the set of deployed containers in the first cloud environment;
based on a comparison between the image scan results and the container identity data, determining, by the service manager, that the particular deployed container of the set of deployed containers is running a vulnerable software product; and
generating, for presentation on a graphic user interface (GUI), information associated with the vulnerable software product.

17. The system of claim 16, wherein the first cloud environment is an isolated cloud environment in the cloud system and only communicates with the second cloud environment on a trusted communication channel.

18. The system of claim 17, wherein the first cloud environment is associated with a first entity and the second cloud environment is associated with a second entity.

19. The system of claim 17, wherein the second entity is a Cloud Service Provider (CSP), and the first entity is a customer of the second entity.

20. One or more non-transitory computer-readable media storing instructions which, when executed by one or more hardware processors, cause performance of operations comprising:
receiving, by a service manager in a first cloud environment of a cloud system for a Cloud Service Provider (CSP), image scan results from a second cloud environment of the cloud system, the image scan results corresponding to a vulnerability scan of a plurality of software products running in a set of deployed containers in the first cloud environment;
receiving, by the service manager, container identity data from a particular deployed container of the set of deployed containers in the first cloud environment;
based on a comparison between the image scan results and the container identity data, determining, by the service manager, that the particular deployed container of the set of deployed containers is running a vulnerable software product; and
generating, by the service manager, information associated with the vulnerable software product for presentation on a GUI.
